(19) United States
(12) Patent Application Publication
(10) Pub. No.: US 2013/0248718 A1
(43) Pub. Date: Sep. 26, 2013

(54) RESONATOR CONTROL APPARATUS

(71) Applicant: KABUSHIKI KAISHA TOSHIBA, Tokyo (JP)

(72) Inventor: Yasutomo SHIOMI, Kanagawa (JP)

(73) Assignee: Kabushiki Kaisha Toshiba, Tokyo (JP)

(21) Appl. No.: 13/770,333

(22) Filed: Feb. 19, 2013

(30) Foreign Application Priority Data
Mar. 23, 2012 (JP) 2012-066953

(51) Int. Cl. G01J 1/42

(52) U.S. Cl. CPC G01J 1/4257
USPC 250/348

(57) ABSTRACT

According to one embodiment, a resonator control apparatus includes: a first light source that outputs resonance light λ₀; a second light source that outputs first control light λ₁; a third light source that outputs second control light λ₂ of a visible wavelength region or a near-infrared wavelength region; a pair of high reflective mirrors whose resonator length is set to (½)×−(wavelength of the resonance light λ₀×integer); a photodetector that monitors transmitted light from the mirror pair; an integrator that captures and integrates two signals detected by the photodetector; a resonator length control unit that controls the resonator length of the mirror pair; and a driver that applies, to the resonator length control unit, a voltage that is calculated by capturing an output signal from the integrator in such a way as to maximize transmittance detected by the photodetector.

### CROSS-REFERENCE TO RELATED APPLICATION(S)

This application is based upon and claims the benefit of priority from the prior Japanese Patent Application No.2012-066953 filed on Mar. 23, 2012, the entire contents of which are incorporated herein by reference.

### FIELD

Embodiments described herein relate generally to a resonator control apparatus.

### BACKGROUND

What is performed is an operation of confining light in a resonator that is made up of high reflective mirrors to cause the light to resonate and increase the intensity of the light, and using the (enhanced) light.

In an enhancement resonator, when the length of the resonator is equal to ½(wavelength×integer), the light resonates. As a result, an enhancement effect is obtained. When enhancement is carried out, the transmittance of the resonator is maximized. In order to allow the state to be maintained, the length of the resonator is controlled with a detector monitoring the transmitted light.

The resonator uses a technique for maintaining a resonant state by using different light, which is used for control, from resonance light that is desired to resonate.

In an enhancement resonator for a middle infrared region or a wavelength region of THz, in order to control the length of the resonator, a MCT (HgCdTe) detector or the like is used. However, the detector requires liquid nitrogen cooling, and is expensive in price, compared with a detector used for wavelength regions such as a visible region or a near-infrared region. Moreover, the detector is low in sensitivity, and is able to respond only by pulse. The detector also has other problems, such as narrow linearity.

### BRIEF DESCRIPTION OF THE DRAWINGS

FIG. 1 is a configuration diagram showing an example of a schematic configuration of a resonator control apparatus according to a first embodiment;

FIG. 2 is a diagram showing an example of emergence of resonance points at a time when light with λ1=0.25 μm and light with λ2=0.31 μm are used as control light;

FIG. 3 is a diagram showing an example of emergence of resonance points at a time when light with λ1=0.75 μm and light with λ2=0.93 μm are used as control light;

FIG. 4 is a configuration diagram showing an example of a schematic configuration of a resonator control apparatus according to a second embodiment; and

FIG. 5 is a configuration diagram showing an example of a schematic configuration of a resonator control apparatus according to a third embodiment.

### DETAILED DESCRIPTION

According to one embodiment, a resonator control apparatus includes: a first light source that outputs resonance light λ0 of a middle-infrared wavelength region or a THz wavelength region; a second light source that outputs first control light λ1 of a visible wavelength region or a near-infrared wavelength region; a third light source that outputs second control light λ2 of a visible wavelength region or a near-infrared wavelength region; a pair of high reflective mirrors whose resonator length is set to (½)×−(wavelength of the resonance light λ0×integer); a photodetector that monitors transmitted light of the first control light λ1 and second control light λ2 transmitted from the mirror pair; an integrator that captures and integrates two signals detected by the photodetector; a resonator length control unit that controls the resonator length of the mirror pair; and a driver that applies, to the resonator length control unit, a voltage that is calculated by capturing an output signal from the integrator and performing a feedback operation in such a way as to maximize transmittance detected by the photodetector, wherein both the first control light λ1 and the second control light λ2 are factors of the resonance light λ0.

Hereinafter, one embodiment of the present invention will be described with reference to the accompanying drawings. Incidentally, the same parts in each diagram are represented by the same reference symbols, and a duplicate description will be omitted.

### First Embodiment

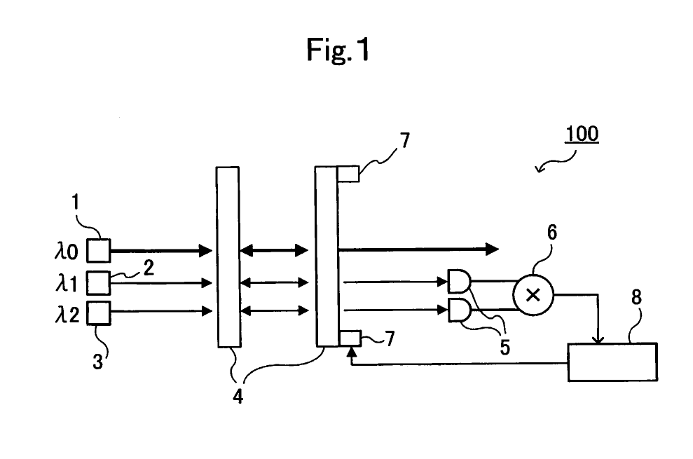

FIG. 1 is a configuration diagram showing an example of a schematic configuration of a resonator control apparatus according to a first embodiment.

As shown in FIG. 1, a resonator control apparatus 100 includes a first light source 1; a second light source 2, which outputs first control light λ₁; a third light source 3, which outputs second control light λ₂; a pair of mirrors 4; a photodetector 5; an integrator 6; a resonator length control unit 7; and a driver 8.

The first light source 1 is designed to output light that is to be resonated, i.e. resonance light λ₀. According to the present embodiment, as the resonance light λ₀, light of a middle-infrared wavelength region is used.

The first control light λ₁ and the second control light λ₂ are used to control the resonator length in such a way as to maximize an enhancement factor, which will be described later. The first control light λ₁ and the second control light λ₂ are emitted to the pair of mirrors 4. For the first control light λ₁, which is emitted from the second light source 2, and for the second control light λ₂, which is emitted from the third light source 3, light of a visible wavelength region or a near-infrared wavelength region is used. Both the first control light λ₁ and the second control light λ₂ may be light of a visible wavelength region. Similarly, all types of light maybe light of a near-infrared wavelength region. Furthermore, according to the present embodiment, the to-be-resonated light λ₀, the first control light λ₁, and the second control light λ₂ are so selected as to be in the following relationship:

λ₀=λ₁×λ₂

That is, λ₁ and λ₂ are factors of λ₀. For example, if λ₀=7.75 μm, the light with λ₁=0.25 μm and the light with λ₂=0.31 μm may be selected as control light. According to the present embodiment, two types of control light are used, and the product of both is calculated. Therefore, the accuracy of detecting a peak-out of a resonance point of λ₁×λ₂ becomes higher than for a peak-out of a resonance point of λ₀ with the use of a single wavelength. As a result, a high-accuracy, optimum resonator length can be obtained.

The above λ₁ and λ₂ may be multiplied by an integer: λ′1=λ₁×M, λ′2=λ₂×N (M, N=integers; M may be equal to N).

For example, if λ0=7.75 μm, the light with λ₁=0.75 μm and the light with λ₂=0.93 μm may be selected as control light at a time when M, N=3.

The pair of mirrors 4 receives the resonance light λ₀, first control light λ₁, and second control light λ₂ that are emitted. The pair of mirrors 4 is so formed that high reflective mirrors are so separated as to face each other with a predetermined distance therebetween. The gap between the mirrors 4 is equal to the resonator length. If the relationship is established in such a way that the resonator length is equal to (½)×−(wavelength of the resonance light λ₀×integer) , the light λ₀ from the first light source 1 resonates, and is confined between the mirrors 4.

The reflectivity of the pair of mirrors 4 is preferably 90 to 99.99% with respect to λ₀, λ₁ and λ₂, for example. The transmittance of the pair of mirrors 4 is 10 to 0.01%. If the transmittance of the pair of mirrors 4 is 1%, the magnitude of the incident light is 1, and the magnitude of the transmitted light is 1, the enhancement factor is 100.

For example, the pair of mirrors 4 is made up of two mirrors held against each other, which are coated with a dielectric multi-layer film. For a substrate material of the pair of mirrors 4, for example, the following are preferred: ZnSe, CaF₂, CdTe, KRS-5, KRS-6, ZnS, Ge, and diamond.

The photodetector 5 is a detector that is sensitive to a wavelength region of the first control light λ₁ and second control light λ₂ that have passed through the pair of mirrors 4. An output signal from the photodetector 5 is transmitted to the integrator 6.

The integrator 6 is designed to capture and integrate two signals detected by the photodetector 5. An output signal from the integrator 6 is transmitted to the driver 8.

The resonator length control unit 7 is a drive unit (actuator) that is designed to control the resonator length, which is a distance between the mirrors 4. For the resonator length control unit 7, piezoelectric elements are preferably used, for example. The elements may be attached to one or more sections of the pair of mirrors 4. Cylindrical piezoelectric elements may also be used to allow light to pass therethrough. The amount of drive of the resonator length is very small on the order of several microns.

The driver 8 is designed to apply, to the resonator length control unit 7, a voltage that is calculated by capturing an output signal from the integrator 6 and performing a feedback operation in such a way as to maximize the transmittance. Based on the deviation of a target value (lock point) and an actual value, feedback is carried out so as to eliminate the deviation. A preferred control method is PID control.

The first light source 1 is so disposed that the resonance light λ₀ from the first light source 1 substantially strikes the center of the pair of mirrors 4. The second light source 2, which outputs the first control light λ₁, and the third light source 3, which outputs the second control light λ₂, are preferably disposed in such a way that the first control light λ₁ and the second control light λ₂ strike an area around the light λ₀ emitted from the first light source 1. Such an arrangement makes it easier to place the photodetector 5, the integrator 6, and other components.

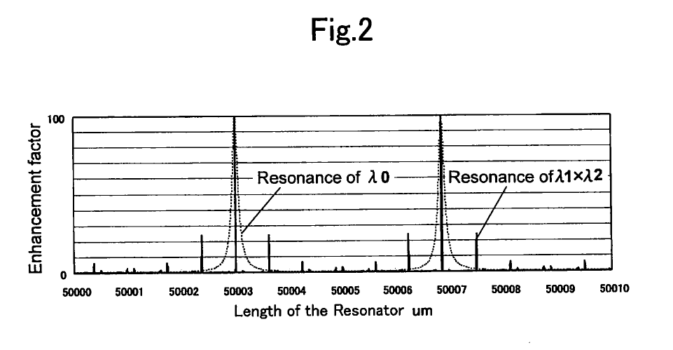

As for the resonator control apparatus 100 having the above configuration, the following describes a process of controlling resonance light with λ₀=7.75 μm. What is shown is an example of emergence of resonance points at a time when the light with λ₁=0.25 μm and the light with λ₂=0.31 μm are used as control light. In FIG. 2, the horizontal axis represents the resonator length (μm), and the vertical axis represents the enhancement factor. As shown in FIG. 2, the peak-outs of the resonance points of the resonance light λ₀ appear at 50004 μm and 50008 μm. Meanwhile, many resonance points of λ₁×λ₂ appear. However, the largest peak-outs appear at 50004 μm and 50008 μm, and are consistent with the peak-outs of the resonance points of the resonance light λ₀. In this manner, the resonance of middle infrared-wavelength λ₀ can be controlled by using λ₁ and λ₂ as control light.

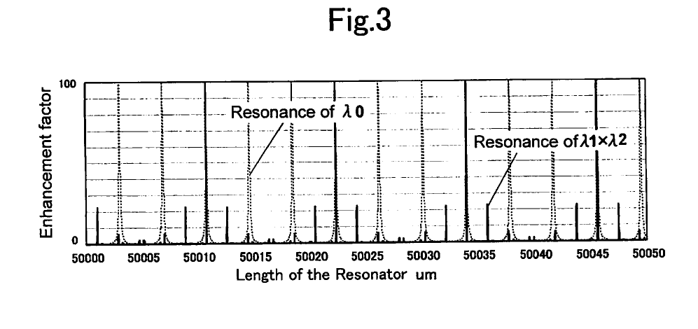

FIG. 3 shows an example of emergence of resonance points at a time when λ₁ and λ₂ are tripled, or when the light with λ₁=0.75 μm and light with λ₂=0.93 μm are used as control light. As shown in FIG. 3, the peak-outs of the resonance points of the resonance light λ₀ appear at 50012 μm, 50031 μm, and other points. Meanwhile, many resonance points of λ₁×λ₂ appear. However, for example, the peak-outs appear at 50012 μm, 50031 μm, and other points, and are consistent with the peak-outs of the resonance points of the resonance light λ₀. In this manner, the resonance of middle infrared-wavelength λ₀ can be controlled by using the visible-wavelength λ₁ and infrared-wavelength λ₂ that have been multiplied by an integer as control light.

According to the present embodiment, without using a detector that works in a middle-infrared region, a detector that works in a visible or near-infrared region, which is much better in sensitivity, responsiveness, and price, can be used to control the resonator length.

### Second Embodiment

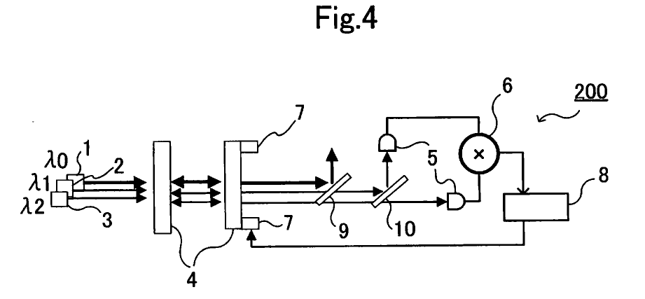

FIG. 4 is a configuration diagram showing an example of a schematic configuration of a resonator control apparatus 200 according to a second embodiment. According to the second embodiment, as shown in FIG. 4, the second light source 2, which outputs the first control light λ₁, and the third light source 3, which outputs the second control light λ₂, are coaxially disposed such that the first control light λ₁ and the second control light λ₂, as well as the light λ₀ from the first light source 1, substantially strike the center of the pair of mirrors 4.

In addition to the components shown in FIG. 1, the resonator control apparatus 200 includes a filter 9 and a dichroic mirror 10. The filter 9 is designed to reflect or absorb the light λ₀ from the first light source 1, and allow the first control light λ₁ and the second control light λ₂ to pass therethrough.

The dichroic mirror 10 is designed to separate the first control light λ₁ from the second control light λ₂. What is shown in FIG. 4 is one example in which the first control light λ1 is reflected, and the second control light λ2 passes therethrough.

According to the second embodiment, three types of light are coaxially disposed, making it possible to make the pair of mirrors 4 compact. Moreover, an optical-axis adjustment can be made by visible light, not by invisible middle-infrared light.

### Third Embodiment

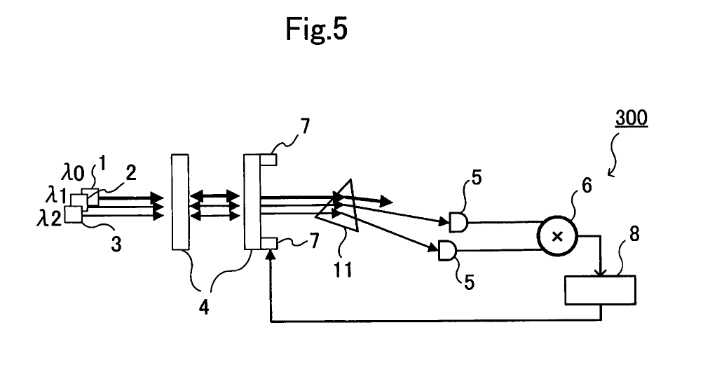

FIG. 5 is a configuration diagram showing an example of a schematic configuration of a resonator control apparatus 300 according to a third embodiment. According to the third embodiment, as shown in FIG. 5, the second light source 2, which outputs the first control light λ₁, and the third light source 3, which outputs the second control light λ₂, are coaxially disposed such that the first control light λ₁ and the second control light λ₂, as well as the light λ₀ from the first light source 1, substantially strike the center of the pair of mirrors 4.

In addition to the components shown in FIG. 1, the resonator control apparatus 300 includes a light dispersion element 11. For example, the light dispersion element 11 is preferably a prism.

The prism is designed to change each of the directions of optical paths of the light λ₀ from the first light source, the first control light λ₁, and the second control light λ₂.

According to the third embodiment, three types of light are coaxially disposed, making it possible to make the pair of mirrors 4 compact. Moreover, an optical-axis adjustment can be made by visible light, not by invisible middle-infrared light. Furthermore, a structure that disperses the light can be simplified.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A resonator control apparatus, comprising:
a first light source that outputs resonance light λ₀ of a middle-infrared wavelength region or a THz wavelength region;
a second light source that outputs first control light λ₁ of a visible wavelength region or a near-infrared wavelength region;
a third light source that outputs second control light λ₂ of a visible wavelength region or a near-infrared wavelength region;
a pair of high reflective mirrors whose resonator length is set to (½)×−(wavelength of the resonance light λ₀×integer);
a photodetector that monitors transmitted light of the first control light λ₁ and second control light λ₂ transmitted from the mirror pair;
an integrator that captures and integrates two signals detected by the photodetector;
a resonator length control unit that controls the resonator length of the mirror pair; and
a driver that applies, to the resonator length control unit, a voltage that is calculated by capturing an output signal from the integrator and performing a feedback operation in such a way as to maximize transmittance detected by the photodetector, wherein
both the first control light λ₁ and the second control light λ₂ are factors of the resonance light λ₀.

2. The apparatus according to claim 1, wherein
the mirror pair includes two mirrors held against each other, which are coated with a dielectric multi-layer film.

3. The apparatus according to claim 1, wherein
a substrate material of the mirror pair is ZnSe, CaF2, CdTe, KRS-5, KRS-6, ZnS, Ge, or diamond.

4. The apparatus according to claim 2, wherein
a substrate material of the mirror pair is ZnSe, CaF2, CdTe, KRS-5, KRS-6, ZnS, Ge, or diamond.

5. The apparatus according to claim 1, wherein
the photodetector is sensitive to the first control light λ₁ and the second control light λ₂.

6. The apparatus according to claim 1, wherein
the resonator length control unit is a piezoelectric element.

7. The apparatus according to claim 1, wherein
the first control light λ₁ and the second control light λ₂ are multiplied by M and N, respectively, before being used as control light (M, N=integers).

8. The apparatus according to claim 2, wherein
the first control light λ₁ and the second control light λ₂ are multiplied by M and N, respectively, before being used as control light (M, N=integers).

9. The apparatus according to claim 3, wherein
the first control light λ₁ and the second control light λ₂ are multiplied by M and N, respectively, before being used as control light (M, N=integers).

10. The apparatus according to claim 4, wherein
the first control light λ₁ and the second control light λ₂ are multiplied by M and N, respectively, before being used as control light (M, N=integers).

11. The apparatus according to claim 7, wherein
the value of M is equal to the value of N.

12. The apparatus according to claim 8, wherein
the value of M is equal to the value of N.

13. The apparatus according to claim 9, wherein
the value of M is equal to the value of N.

14. The apparatus according to claim 10, wherein
the value of M is equal to the value of N.

15. The apparatus according to claim 1, wherein:
the first light source is so disposed that the resonance light λ₀ from the first light source substantially strikes the center of the mirror pair; and the second light source and the third light source are so disposed that the first control light λ₁ and the second control light λ₂ strike an area around the resonance light λ₀.

16. The apparatus according to claim 1, wherein:
the first light source, the second light source, and the third light source are concentrically disposed so that the resonance light λ₀, the first control light λ₁, the second control light λ₂ substantially strike the center of the mirror pair; and
the apparatus includes
a filter that reflects or absorbs the resonance light λ₀, and allows the first control light λ₁ and the second control light λ₂ to pass therethrough, and
a dichroic mirror that separates the first control light λ₁ from the second control light λ₂.

17. The apparatus according to claim 1, wherein:
the first light source, the second light source, and the third light source are concentrically disposed so that the resonance light λ₀, the first control light λ₁, the second control light λ₂ substantially strike the center of the mirror pair; and
the method includes a light dispersion element that changes each of directions of optical paths of the resonance light λ₀, the first control light λ₁, and the second control light λ₂.

18. The apparatus according to claim 17, wherein,
the light dispersion element is a prism.
